(19) United States
(12) Patent Application Publication
(10) Pub. No.: US 2010/0118550 A1
(43) Pub. Date: May 13, 2010

(54) Rotary-clasp type LED package

(76) Inventor: Hung-Pin Kuo, Sigang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,147

(22) Filed: Jan. 21, 2009

(30) Foreign Application Priority Data
Nov. 7, 2008 (TW) 097143201

(51) Int. Cl. F21K 7/00; G02B 7/02

(52) U.S. Cl. 362/311.02; 359/818

(57) ABSTRACT

A LED lens and a LED package using the LED lens are disclosed. The LED lens includes a holder and a lens. The holder has a frame and a plurality of arms extending from bottoms of the frame. The lens is mounted on the frame of the holder. In particular, the holder is capable of clasping a mounting base of the LED assembly by the arms when the holder is placed upon the LED assembly and rotated with respect to the LED assembly by an angle.

### BACKGROUND OF INVENTION

1. Field of Invention

This invention relates to a light emitting diode (LED) package and more particularly to a LED package having a LED lens capable of clasping a LED assembly thereof.

2. Related Prior Art

LED packages are known in the art. Such packages are generally as designed to assemble a LED lens and a LED assembly together securely.

Taiwan Patent No. M313317 is an exemplary of patent directed to LED package of the type to which this invention is directed. As disclosed in that patent, the LED package adopts an adhesive, such as epoxy, to combine a LED lens and a LED assembly together; however, the LED package is relatively time-consuming and costly to manufacture because of the high-temperature baking procedure.

Another LED package is described in Taiwan Patent No. M338431 and includes a lens, a holder and a LED assembly. The lens is mounted onto a mounting base of the LED assembly with the help of the holder. Specifically, the holder is formed with two hooks for engagement with two diagonal corners of the mounting base of the LED assembly. Further, the holder is formed with two positioning bolts to be received in two corresponding positioning holes of the mounting base of the LED assembly. There is need to preciously place the holder in right position in order to insert its two positioning bolts into the two positioning holes of the mounting base of the LED assembly for further assembly. The positioning construction is needed in this type of LED package. It is because once the mounting base of the LED assembly is not the kind having positioning holes, then that kind of holder becomes useless. Additionally, none of the parts of the LED package can be easily detached from one another for replacement once the lens, the holder and the LED assembly are bonded together.

### SUMMARY OF INVENTION

Broadly stated, the present invention is directed to a LED package which is easy and fast to be assembled. The LED package generally includes a LED assembly and a LED lens. The LED lens is provided to be quickly attached on a mounting base of the LED assembly. Specifically, the mounting base of the LED assembly is formed with a plurality of ledges at corners. The LED lens includes a lens and a holder through which the lens is secured on the mounting base of the LED assembly. The holder includes a frame and a plurality of arms extending from bottoms of the frame. The lens is mounted on top of the frame of the holder. The holder is capable of clasping a mounting base of the LED assembly by the arms when the holder is placed upon the LED assembly and rotated with respect to the LED assembly by an angle. When the LED lens and the LED assembly are tightly joined together, the ledges of the mounting base are clasped in the arms of the holder.

Preferably, each of the arms of the holder has a fixed section and a forearm extending from a front side of the fixed section. The forearm is elastic. The forearm and the frame co-define a breach therebetween. Moreover, a free end of the forearm of one arm and a rear end of the fixed section of another arm co-define a gap in communication with the breach. The ledges of the mounting base of the LED assembly are to be confined in the breach.

Preferably, the holder and the lens of the LED lens are one piece formed construction so that the LED package is relatively cost-effective.

The present invention and the advantages thereof will become more apparent upon consideration of the following detailed description when taken in conjunction with the accompanying drawings.

### BRIEF DESCRIPTION OF DRAWINGS

The invention is illustrated by the accompanying drawings in which corresponding parts are identified by the same numerals and in which:

FIG. 1 is a perspective view of a LED package in accordance with a first embodiment of the present invention;

FIG. 2 is an exploded downward perspective view of the LED package of FIG. 1;

FIG. 3 is an exploded upward perspective view of the LED package of FIG. 1;

FIG. 4 is a cross-sectional view, partially broken away to show details of construction, of the LED package of FIG. 1;

FIG. 5 is a perspective view, partially broken away to show details of construction, of the LED package of FIG. 1, showing that the holder of the LED lens is placed upon the LED assembly before relative rotation;

FIG. 6 is a view similar to FIG. 5, illustrating the holder of the LED lens is rotated with respective to the LED assembly;

FIG. 7 is an exploded view of a LED package in accordance with a second embodiment of the invention; and

FIG. 8 is an exploded view of a LED package in accordance with a third embodiment of the invention.

### DETAILED DESCRIPTION OF EMBODIMENTS

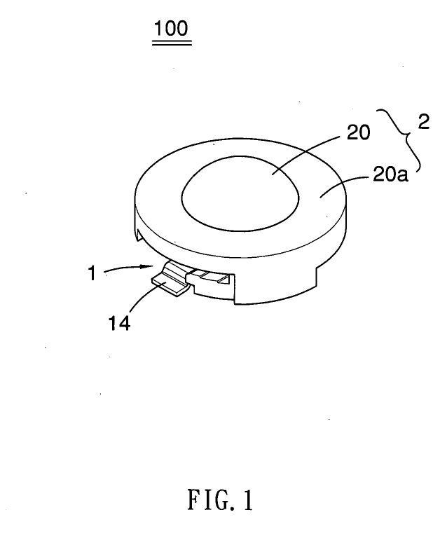

Referring now to FIGS. 1-6, the LED package 100 according to a first embodiment of the present invention comprises a LED assembly 1 and LED lens 2 attached to the LED assembly 1.

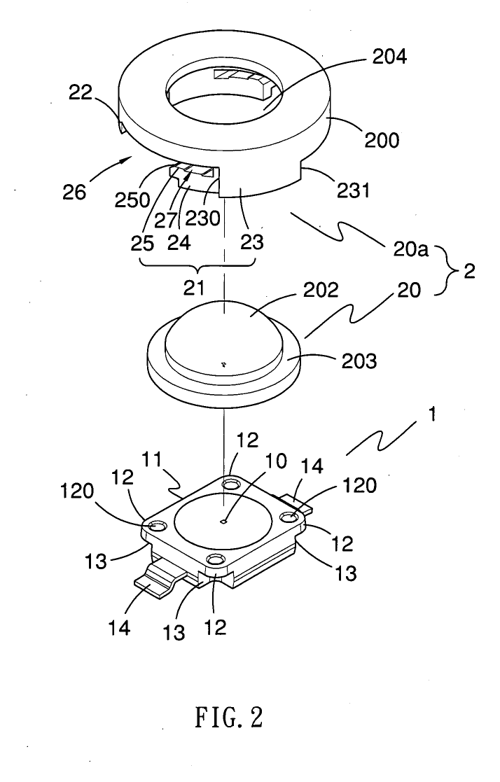

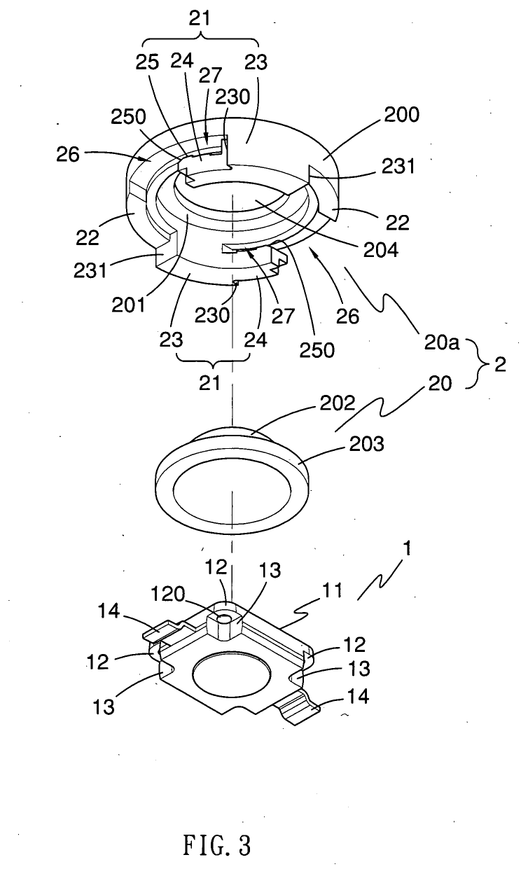

As shown in FIGS. 2 and 3, the LED assembly 1 includes a mounting base 11 and a LED die 10 mounted on a central part of the mounting base 11. The mounting base 11 is substantially square-shaped and is formed with a plurality of ledges 12 at corners thereof. Each of the ledges 12 defines a positioning hole 120 therein. The ledges 12 are flush with other top areas of the mounting base 11. Under each of the ledges 12 is a notch 13 defined in a lower corner of the mounting base 11. Additionally, a pair of leads 14 extends from opposite sides of the mounting base 11 and is electrically connected to the LED dies 10.

As best shown in FIG. 3, the LED lens 2 is adapted for quick attachment to the LED assembly 1 and includes a holder 20a and a lens 20. The holder 20a includes a frame 200, a confining portion 201, two protruding rails 22 and two arms 21. The frame 200 is hollow and the confining portion 201 is disposed on an inner peripheral wall of the hollow frame 200. The two arms 21 extend from bottoms of the frame 200. The lens 20 is mounted on the frame 200 of the holder 20a and includes a lens body 202 and a fixing portion 203 extending from a periphery of the lens body 202. In this embodiment, the fixing portion 203 of the lens 20 is a fixing ring mounted around the lens body 202. The confining portion 201 is constructed corresponding to the fixing portion 200 of the lens 20.

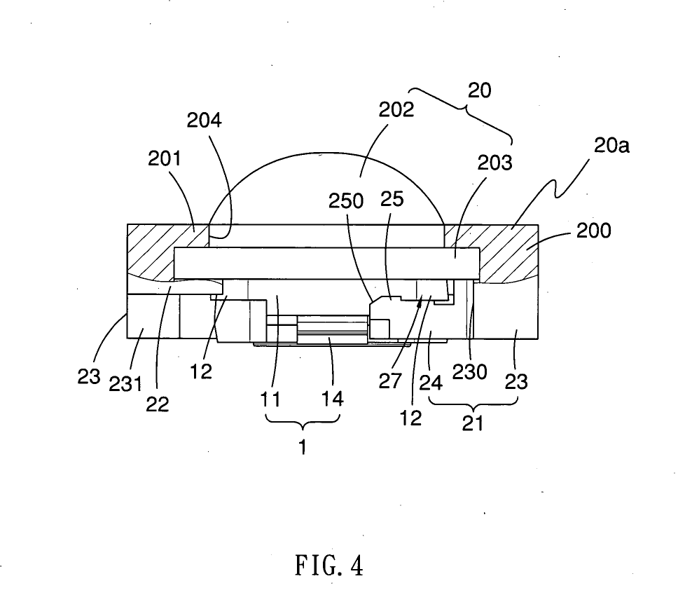

FIG. 4 illustrates that the lens 20 is secured on the mounting base 11 of the LED assembly 1 as a result of the fixing portion 20 of the lens 20 being restrained by the confining portion 201 of the holder 20a. That is, the confining portion 201 of the holder 20a presses the fixing portion 203 of the lens 20 against the mounting base 11 of the LED assembly 1 so as to have the lens 20 be secured in position on the LED assembly 1. In this embodiment, the confining portion 201 of the holder 20a is an annular plate defining a window 204 in the center thereof. The lens body 202 of the lens 20 is partly received in the window 204 and is exposed outside the frame 200 of the holder 20 via the window 204. Additionally, the lens body 202 of the lens 20 is constructed and based on an optical system. For instance, the lens body 202 may be domed-shaped as described in this embodiment, and may be concave and not exposed outside the frame 200 of the holder 20a. In any case, the lens body 202 of the lens 20 is exposed in the window 204, without being blocked by the frame 200 of the holder 20a.

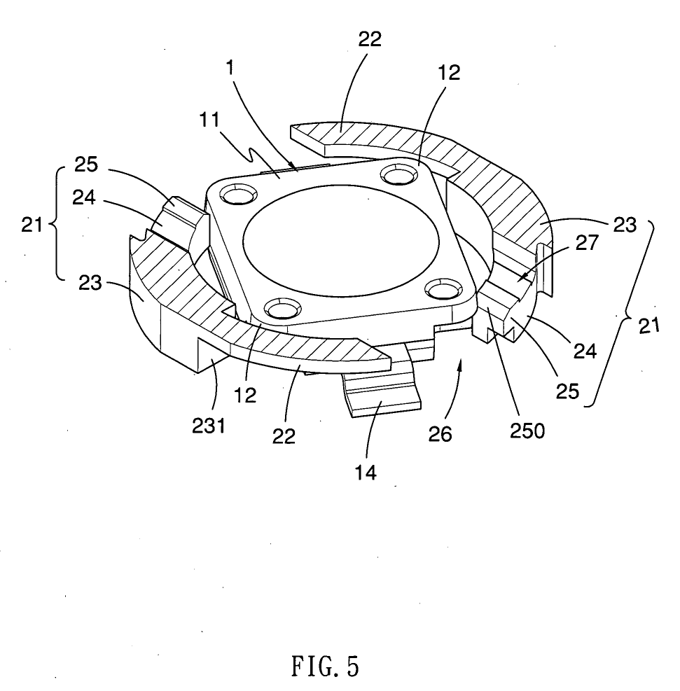

In order to have the LED lens 2 be able to be fast mounted on the mounting base 11 of the LED assembly 1, the holder 20a are configured to clasp the mounting base 11 of the LED assembly 1 by the arms 21 when the holder 20a is placed upon the LED assembly 1 and rotated with respect to the LED assembly 1 by an -angle. Specifically, as shown in FIGS. 3 and 5, the two arms 21 are corresponding to each other and each includes a fixed section 23,a forearm 24 and a positioning bulge 25. The fixed section 23 of the arm 21 extends from a bottom of the frame 200. The forearm 24 extends from a front side 230 of the fixed section 23. Since the LED lens 2 is made of an elastic material, the forearm 24 of the arm 21 is elastic. Moreover, a breach 27 is defined between the forearm 24 and the frame 200. As best shown in FIG. 3, a free end of the forearm 24 of one arm 2 land a rear end 231 of the fixed section 23 of the other arm 21 co-define a gap 26 in communication with the breach 27. The positioning bulge 25 of the arm 21 extends from a top of the free end of the forearm 24 toward a bottom of the frame 200 and is formed with a slope 250 at a side facing the gap 26.

As shown in FIG. 5, each of the protruding rails 22 of the holder 20a extends from the rear side 231 of the fixed section 23 of the respective arm 21 along a peripheral of the frame 200 toward the gap 26. The gaps 26 of the arms 21 are specifically sized in accordance with the width of the mounting base 11 of the LED assembly 1 in order to fit the mounting base 11. When the holder 20a is placed upon the mounting base 11 of the LED assembly 1, diagonal two of the ledges 12 of the mounting base 11 are bound by inner walls of the protruding rails 22 of the holder 20a in such a way that the mounting base 11 of the LED assembly 1 is free from coming off.

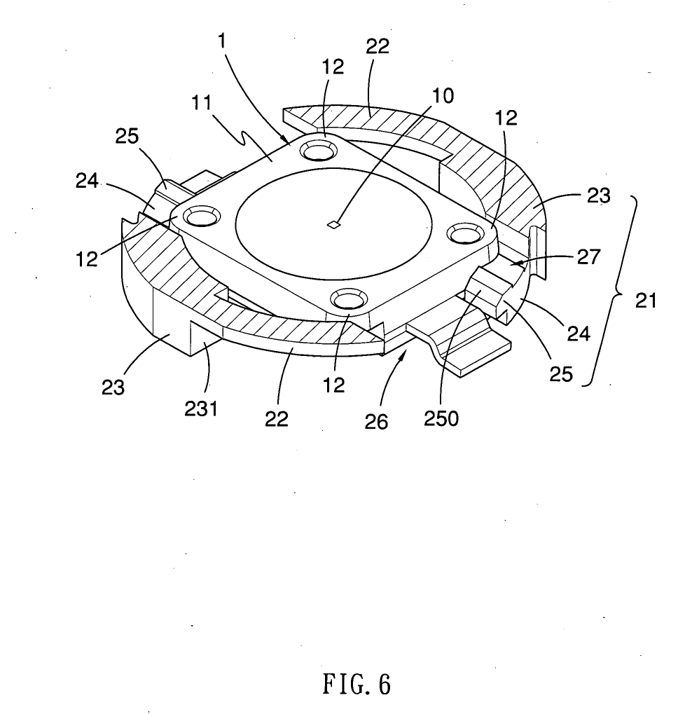

Referring to FIG. 6, when the holder 20a of the LED lens 2 is rotated with respective to the mounting base 11 of the LED assembly 1, the diagonal two ledges 12 move along the inner walls of the protruding rails 22 of the holder 20a to have the other two diagonal ledges 12 be snapped into the breaches 27 of the arms 21 respectively. It is because while the other two diagonal ledges 12 pass along the slopes 250 of the positioning bulges 25 for entering into the breaches 27, the positioning bulges 25 together with the elastic forearm 24 is pressed downward a bit by the moving ledges 12, but are then rebounded after the ledges 12 move off the bulges 25 and enter into the breaches 27. At this time, the other two diagonal ledges 12 of the mounting base 11 are clasped in the arms 21 of the holder 20a. As shown in FIG. 6, the positioning bulge 25 of the arm 21 stops the ledge 12 from withdrawal from the breach 27. In this embodiment, four ledges 12 are included in the mounting base 1 of the LED assembly 1. It should be noted that only two or three ledges may also be used as long as the cooperated parts, such as arms 21 and protruding rails 22 of the holder 20a are provided correspondingly.

From the foregoing description, the present invention provides a convenient, efficient, and cost effective solution to the LED package industry. The lens 20 can be easily, fast mounted on the mounting base 11 of the LED assembly 1 without need of accurate alignment procedure or time-consuming baking procedure as mentioned in the prior art. Once a LED package is assembled and is found deficient due to a failure lens 2 or LED assembly 1, the deficient LED package can be immediately disassembled and have the failure part be replaced. Additionally, for some other LED mounting bases having no positioning holes therein, the holder 20a can also be applied.

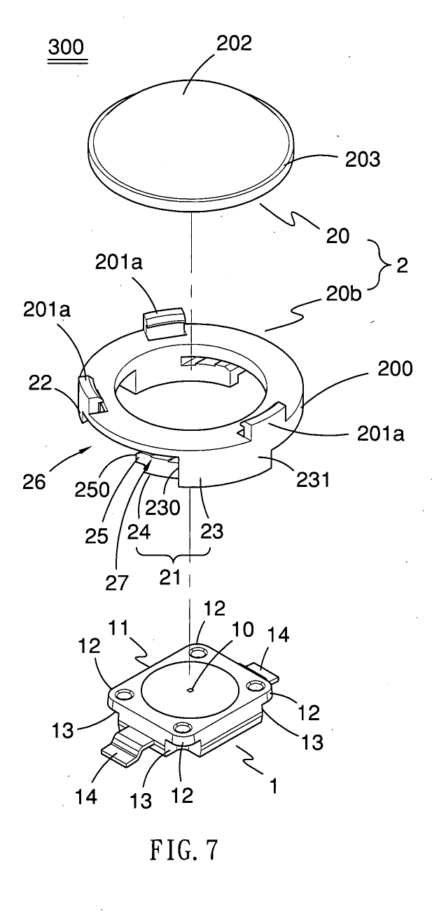

FIG. 7 provides an explosive perspective view of a LED package 300 in a second embodiment. As with LED package 100 of FIGS. 1-6, the LED package 300 of the second embodiment includes a LED assembly land a LED lens 2 attached on the LED assembly 1. The LED lens 2 has a holder 20b and a lens 20 mounted on the holder 20b. Substantially all of the precepts discussed in the first embodiment apply to the second embodiment. The major difference is that the confining portion 201a of the second embodiment includes three hooks rather than an annular plate 201 as illustrated in the first embodiment. The three hooks, namely the confining portion 201a, are provided to catch the fixing portion 203 of the lens 20 in order to secure the lens 20 on top of the frame 200 of the holder 20b.

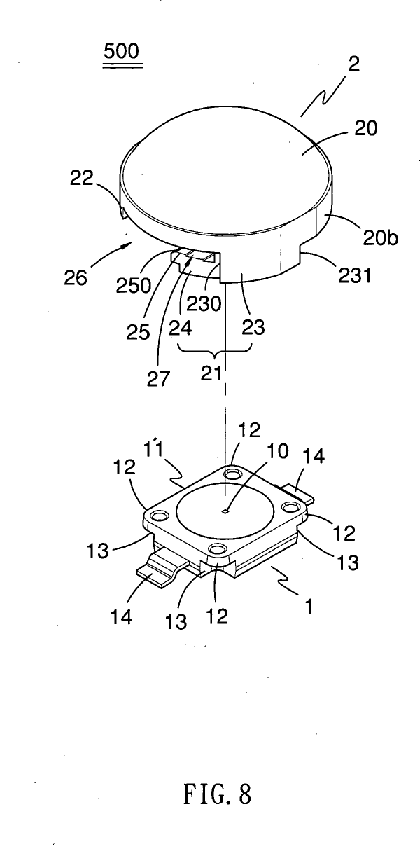

With reference to FIG. 8, a LED package 500 in accordance with a third embodiment of the invention is illustrated. The third embodiment is similar to the LED package 300 of the second embodiment, except that the lens 20 and the holder 20b are one piece formed by molding, which is relatively cost-efficient.

It will be appreciated that although the embodiments of the invention have been shown and described, modifications may be made. It is intended in the claims to cover such modifications which come within the spirit and scope of the invention.

The invention claimed is:

1. A LED lens for attachment to a LED assembly, comprising:
a holder having a frame and a plurality of arms extending from bottoms of the frame; the holder being capable of clasping a mounting base of the LED assembly by the arms when the holder is placed upon the LED assembly and rotated with respect to the LED assembly by an angle; and
a lens mounted on the frame of the holder.

2. The LED lens of claim 1, wherein each of the arms of the holder has a fixed section and a forearm extending from a front side of the fixed section; the forearm is elastic; the forearm and the frame co-define a breach therebetween; and a free end of the forearm of one arm and a rear end of the fixed section of another arm co-define a gap in communication with the breach.

3. The LED lens of claim 2, wherein the holder further has a plurality of protruding rails each extending from the rear side of the fixed section of the respective arm along a peripheral of the frame toward the gap.

4. The LED lens of claim 3, wherein each of the arms of the holder further has a positioning bulge extending from a top of the forearm toward a bottom of the frame.

5. The LED lens of claim 4, wherein the positioning bulge of the arm has a slope facing the gap.

6. The LED lens of claim 5, wherein the holder and the lens are one piece formed construction.

7. The LED lens of claim 2, wherein the lens has a lens body and a fixing portion extending from a periphery of the lens body; and the holder further has a confining portion extending from the frame and corresponding to the fixing portion of the lens so that the confining portion of the holder is able to press the fixing portion of the lens against the mounting base of the LED assembly in order to secure the lens on the LED assembly.

8. The LED lens of claim 7, wherein the fixing portion of the lens is a ring mounted around the lens body.

9. The LED lens of claim 8, wherein the confining portion of the holder is an annular plate defining a window in which the lens body of the lens is exposed.

10. The LED lens of claim 8, wherein the confining portion of the holder includes a plurality of hooks for engagement with the fixing portion of the lens.

11. A LED package comprising:
a holder having a frame and a plurality of arms extending from bottoms of the frame; and
a lens mounted on the frame of the holder;
a LED assembly having a mounting base and a light emitting diode mounted on the mounting base; the mounting base being formed with a plurality of ledges clasped in the arms of the holder.

12. The LED package of claim 11, wherein each of the arms of the holder has a fixed section and a forearm extending from a front side of the fixed section; the forearm is elastic; the forearm and the frame co-define a breach therebetween; a free end of the forearm of one arm and a rear end of the fixed section of another arm co-define a gap in communication with the breach; and the ledges of the mounting base are confined in the breach.

13. The LED package of claim 12, wherein the holder further has a plurality of protruding rails each extending from the rear side of the respective arm and together surrounding the LED assembly.

14. The LED package of claim 13, wherein each of the arms of the holder further has a positioning bulge extending from a top of forearm toward a bottom of the frame so as to restrain the ledge of the LED assembly from withdrawal out of the breach.

15. The LED package of claim 14, wherein the positioning bulge of the arm has a slope facing the gap.

16. The LED package of claim 15, wherein the holder and the lens are one piece formed construction.

17. The LED lens of claim 15, wherein the lens has a lens body and a fixing portion extending from a periphery of the lens body; and the holder further has a confining portion extending from the frame and corresponding to the fixing portion of the lens so that the confining portion of the holder is able to press the fixing portion of the lens against the mounting base of the LED assembly in order to secure the lens on the LED assembly.

18. The LED lens of claim 17, wherein the fixing portion of the lens is a ring mounted around the lens body.

19. The LED lens of claim 18, wherein the confining portion of the holder is an annular plate defining a window in which the lens body of the lens is exposed.

20. The LED lens of claim 18, wherein the confining portion of the holder includes a plurality of hooks for engagement with the fixing portion of the lens.
